(19) United States
(12) Patent Application Publication
(10) Pub. No.: US 2016/0233491 A1
(43) Pub. Date: Aug. 11, 2016

(54) BISMUTH-ANTIMONY ANODES FOR LITHIUM OR SODIUM ION BATTERIES

(71) Applicant: Board of Regents, The University of Texas System, Austin, TX (US)

(72) Inventors: Arumugam Manthiram, Austin, TX (US); Yubao Zhao, Austin, TX (US)

(21) Appl. No.: 15/004,558

(22) Filed: Jan. 22, 2016

Related U.S. Application Data
(60) Provisional application No. 62/112,434, filed on Feb. 5, 2015.

(51) Int. Cl. H01M 4/38; C22C 12/00; H01M 10/0525; H01M 10/054; H01M 4/36; H01M 4/587

(52) U.S. Cl. CPC H01M 4/38; H01M 4/364; H01M 4/587; H01M 4/381; H01M 4/382; H01M 10/0525; H01M 10/054; C22C 12/00; H01M 2004/027

(57) ABSTRACT

The present disclosure relates to bismuth (Bi)-antimony (Sb) anodes for use in rechargeable lithium ion (Li⁺) or sodium ion (Na⁺) batteries, to methods of forming electrochemically active Bi—Sb alloys, and to rechargeable batteries containing such anodes.

### PRIORITY CLAIM

The present application claims priority under 35 U.S.C. §119 to U.S. Provisional Patent Application Ser. No. 62/112,434 filed Feb. 5, 2015 and titled “BISMUTH-ANTIMONY ANODES FOR LITHIUM OR SODIUM ION BATTERIES,” which is incorporated by reference herein in its entirely.

### TECHNICAL FIELD

The present disclosure relates to bismuth (Bi)-antimony (Sb) anodes for use in rechargeable lithium ion (Li⁺) or sodium ion (Na⁺) batteries, to methods of forming electrochemically active Bi—Sb alloys, and to rechargeable batteries containing such anodes.

### BACKGROUND

Rechargeable (secondary) lithium ion batteries are widely utilized in consumer electronic devices such as cell phones and laptop computers owing, in part, to their high energy density. Rechargeable lithium ion batteries are also useful in power-intensive applications, such as in electric vehicles and power tools. Additional uses for rechargeable lithium ion batteries, such as in energy grid storage, are possible.

Although rechargeable sodium ion batteries are less widespread, they may be used in many of the same applications as lithium ion batteries.

A rechargeable battery stores electrical energy as chemical energy in two electrodes, an anode and a cathode. The anode and the cathode are electrically insulated from one another inside the battery by an electrolyte and typically also by a separator. The separator is permeable to ions and allows them to pass between the electrodes inside the battery. Electrons (e⁻) move through an external electronic circuit. The anode and the cathode normally include compounds into which lithium ions and/or lithium atoms or sodium ions and/or sodium atoms may be reversibly inserted. The electrolyte typically contains a lithium or sodium salt dissolved in an organic liquid to produce lithium ions or sodium ions. Often the electrolyte contains an organic liquid, such as a carbonate, an ether, a nitrile or a sulfoxide.

When the battery is discharged, electrons move from the anode to the cathode passing through an external device, such as a phone, which is powered by the electron flow, i.e. current. The current flowing through the external device can also be of electron vacancies, i.e. holes. Lithium ions or sodium ions move from the anode to the cathode at the same time. When the battery is charged, an outside power source, such as a wall socket, supplies the power required for transporting lithium ions or sodium ions through the electrolyte and electrons through the external circuit from the cathode to the anode. Typically, the lithium or sodium formed from the lithium ions or sodium ions and the electrons, combine with, dissolve in, alloy in, or intercalate in a material of the anode. On discharge the flow of ions and electrons is reversed and the lithium or sodium ions combine with, dissolve in, alloy in, or intercalate in a material of the cathode.

Currently graphite is commonly used as an anode material in lithium ion batteries. Graphite exhibits an operating voltage of very near zero vs. Li/Li⁺, which allows the formation of lithium metal dendrites one the anode. Over time, these dendrites can extend to the cathode and cause the battery to have a short circuit and cease to function. In addition, this low operating voltage allows the formation of a solid-electrolyte interphase (SEI) layer on the electrode surface which passivates the electrode and causes low initial coulombic efficiency and decreased rate capacity, making the battery less desirable to use and/or less long-lived.

Lithium metal suffers from similar problems when used as an anode. Attempts to alleviate theses problems by forming lithium metal alloys have only led to new problems, such as steep potential profiles or large volume changes during charging and discharging, which ultimately impairs the structural integrity of the anode and decreases battery life. In addition, many of these alloys operate at near zero vs. Li/Li⁺, allowing the formation of dendrites and/or SEI layers. Attempts to address some of these problems have included forming particular alloy structures that decrease the effects of volume changes. However, these structures are often complicated and expensive to form. Other attempts include forming alloys that do not experience large volume changes, but these alloys tend to present sloping voltage curves, which causes variations in battery performance and output over the discharge cycle. Such variations are not desirable, as many electrical devices do not tolerate them well or cannot operate with such variations.

Similar problems are exhibited by sodium ion battery anode materials.

### BRIEF DESCRIPTION OF THE DRAWINGS

The accompanying figures, which are incorporated in and constitute a part of this specification, illustrate several aspects and together with the description serve to explain the principles of the invention. The current specification contains color drawings. Copies of these drawings may be obtained from the USPTO.

FIG. 1 depicts a rechargeable lithium ion battery with an anode containing a Bi—Sb alloy.

FIG. 2 depicts a high-energy mechanical milling method for forming Bi—Sb alloy.

FIG. 3A is a scanning electron microscopy (SEM) image of the Bi_{0.36}Sb_{0.64}-C.

FIG. 3B is an energy dispersive spectroscopy (EDS) line scan profile along the direction marked in FIG. 3A.

FIG. 3C is an EDS elemental map of Sb; FIG. 3D is an EDS elemental map of Bi.

FIG. 4A is X-ray diffraction (XRD) patterns of the indicated Bi—Sb alloys. The lines in the lower part of the graph are the standard diffraction peaks of Sb (hollow triangle) and Bi (hollow rectangle).

FIG. 4B is the atomic arrangement of a Bi crystal with the lattice pattern shown below the crystal structure.

FIG. 4C is the atomic arrangement of a Bi_{0.57}Sb_{0.43} crystal with the lattice pattern shown below the crystal structure.

FIG. 4D is the atomic arrangement of a Bi_{0.36}Sb_{0.64} crystal with the lattice pattern shown below the crystal structure.

FIG. 4E is the atomic arrangement of a Sb crystals with the lattice pattern shown below the crystal structure.

FIGS. 5A-D present discharge-charge potential profiles of electrodes at galvanostatic condition with a current density of 200 mA g⁻¹. The electrode in FIG. 5A is Bi—C. The electrode in FIG. 5B is Sb—C. The electrode in FIG. 5C is Bi_{0.57}Sb_{0.43}—C. The electrode in FIG. 5D is Bi_{0.36}Sb_{0.64}—C.

FIGS. 6A-D present potential profiles of electrodes at the 10^{th} cycle. The electrode in FIG. 6A is Bi—C. The electrode in FIG. 6B is Sb—C. The electrode in FIG. 6C is Bi_{0.57}Sb_{0.43}—C. The electrode in FIG. 6D is Bi_{0.36}Sb_{0.64}—C.

FIG. 6E presents capacities of the voltage plateaus of each electrode from FIGS. 6A-D.

FIG. 7 presents cycle performance of electrodes at galvanostatic condition with a current density of 200 mA

FIGS. 8A and B present cycle performance and Coulombic efficiency of electrodes in lithium-ion batteries. The electrode in FIG. 8A is Bi_{0.57}Sb_{0.43}—C. The electrode in FIG. 8B is Bi_{0.36}Sb_{0.64}—C.

FIGS. 9A and B present the rate capacities of electrodes. The electrodes in FIG. 9A are Bi—C and Sb—C. The electrodes in FIG. 9B are Bi_{0.57}Sb_{0.43}—C and Bi_{0.36}Sb_{0.64}—C.

FIGS. 10A-D present potential profiles of the materials in sodium ion batteries. The electrode in FIG. 10A is Bi—C. The electrode in FIG. 10B is Sb—C. The electrode in FIG. 10C is Bi_{0.57}Sb_{0.43}—C. The electrode in FIG. 10D is Bi_{0.36}Sb_{0.64}-C.

FIG. 11A presents cycle performance of electrodes in sodium ion batteries at galvanostatic condition with current at 100 mA g⁻¹.

FIG. 11B presents C rate performance of electrodes in a sodium ion battery.

FIGS. 12A-D present cyclic voltammetry (CV) scans of the lithiation/delithiation process of electrodes. The electrode in FIG. 12A is Bi_{0.36}Sb_{0.64}—C. The electrode in

FIG. 12B is Bi_{0.57}Sb_{0.43}—C. The electrode in FIG. 12C is Sb—C. The electrode in FIG. 12D is Bi—C.

### DETAILED DESCRIPTION

The present disclosure relates to Bi—Sb anodes for use in rechargeable lithium ion or sodium ion batteries, to methods of forming electrochemically active Bi—Sb alloys, and to rechargeable batteries containing such anodes.

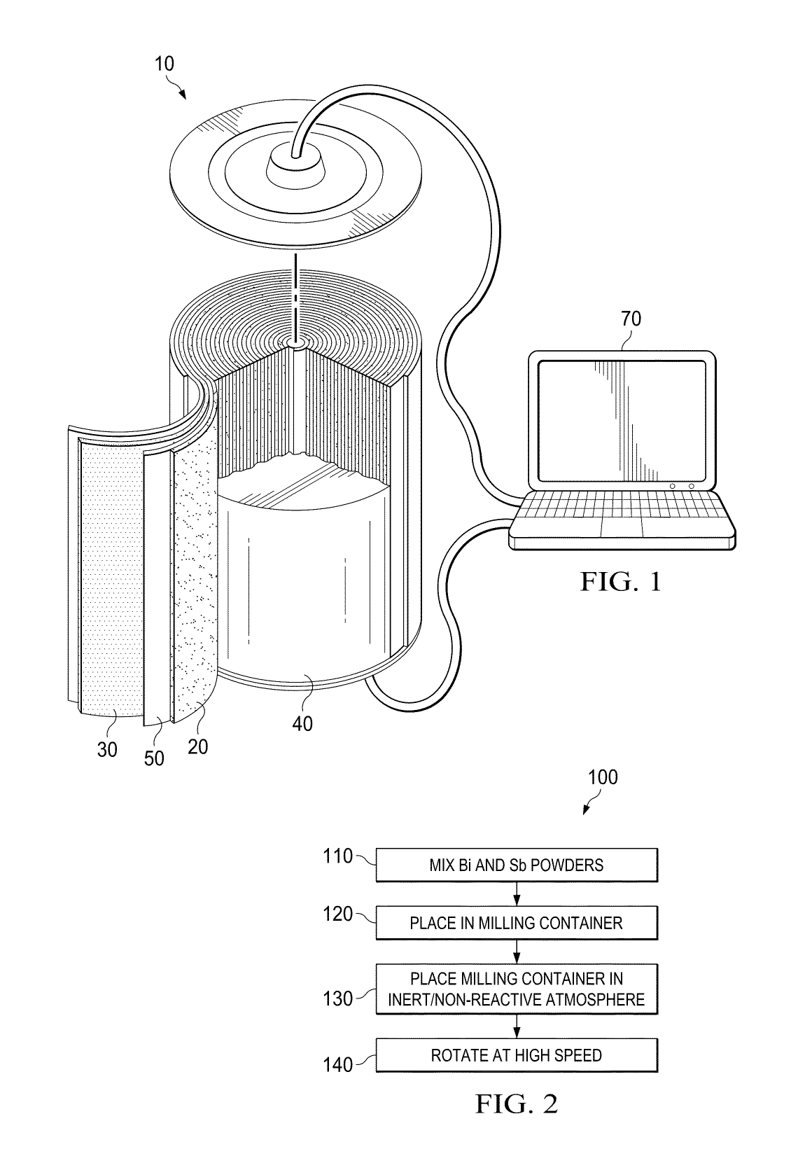

The present disclosure relates to an anode 20, which may be included in a rechargeable battery 10. Battery 10 may also include a cathode 30 and an electrolyte 40 as shown in FIG. 1. Battery 10 may additionally include separator 50. Battery 10 may contain contacts which facilitate connection to an external device 70, which may be powered by the battery or which may recharge the battery. Battery 10 may be a lithium ion or sodium ion battery.

Anode 20 includes a Bi—Sb alloy. When lithium ions are present in anode 20, the anode may further contain Li—Bi and/or Li—Sb compounds The lithiated compounds are typically in the forms of Li₃Bi and Li₃Sb. According to CV studies, Li₃Sb forms shortly prior to Li₃Bi during discharge. Similarly, when sodium ions are present in anode 20, the anode may further contain Na—Bi and/or Na—Sb compounds, such as Na₃Sb and Na₃Bi. It will be understood by one of skill in the art that the active anode material may contain more or less lithium or sodium depending on the state of charge of anode 20. The ratio of Bi:Sb in anode 20 may range from 1:9 to 9:1. The Bi—Sb alloy may form the same type of crystal regardless of ratios of Bi and Sb. In particular, the Bi—Sb alloy may have a crystal structure in the R-3m space group. The Bi—Sb alloy may be homogenous, as confirmed using XRD.

Carbon, such as elemental carbon (C) may be included in the alloy in order to further enhance conductivity. Carbon may form up to 30% of the alloy by weight, such as up to 20% by weight. Carbon may be in any form able to enhance conductivity and may be included in the alloy during the alloying process or provided later. Carbon present in the anode may be outside of the Bi—Sb crystals, as may be confirmed using XRD. In particular, it may coat the crystals. Anode 20 may further include a current collector. In addition, anode 20 may include the Bi—Sb alloy as an active material along with other materials, such as binder or conductivity enhancers.

The operating voltage of anode 20 is approximately 0.8 to 1.0 V vs. Li/Li⁺, with some variation depending on the amount of Bi present. Anode 20 may exhibit a substantially flat voltage plateau. For instance, the voltage may change less than 5% during a time frame that represents 90% of the time required for charge or discharge. Bi and Sb can alloy in any ratio, meaning that formation of Li—Bi and/or Li—Sb compounds or Na—Bi and/or Na—Sb compounds has little effect on the potential of anode 20. The flat voltage plateau allows battery 10 to have a higher energy density, such as 480 Wh/Kg for lithium ion batteries or 330 Wh/Kg for sodium ion batteries.

Furthermore even at high current rates such as 3 A/g, dendrites do not form on anode 20 or do not become sufficiently large to cause the battery to short circuit during normal battery life, such as 300 cycles. This renders battery 10 safer than many other alternatives in which the anode often forms dendrites in at least a substantial number of batteries during normal battery life.

Cathode 30 which may include a cathode material on a current collector. The current collector may be, for example, made of a copper foil or an aluminum foil. The cathode material may contain a compound that allows reversible insertion of lithium or sodium ions at a potential more oxidizing than that of the anode. The cathode material may also contain an electronic conducting agent or a binder. The cathode material may be selected from transition-metal oxides able to provide a host framework into which lithium ion may be reversibly inserted and extracted. For example, the active cathode material may include a lithium transition-metal oxide, such as LiCoO₂ and LiMn_{1.5}Ni_{0.5}O₄, a lithium transition-metal polyanion oxide, such as LiFePO₄ or other phosphates, sulfonates, vanadates, or arsenates, oxygen, a peroxide, such as a Li₂O₂, sulfur, a sulfur-polymers, a sulfoselenides, and any other known or later discovered cathode material for which a compatible electrolyte and suitable voltage may be obtain with an anode as described herein. Also for example, the cathode material may have a layered, olivine, spinel, or rhombohedral NASICON structure.

For sodium ion batteries, suitable cathode materials include Na₂FePO₄F, NaVPO₄F, NaV₁₋ₓCrₓPO₄F, NaₓVO₂, Na₄Fe(CN)₆, Na_{1.5}VPO_{4.8}F_{0.7}, P2-Naₓ[Ni_{1/3}Mn_{2/3}]O₂, wherein (0<x<2/3), sodium-containing layered oxides, and any other known or later discovered cathode material for which a compatible electrolyte and suitable voltage may be obtained with an anode as described herein.

Cathodes and anodes may combine more than one type of electrochemically active material.

The battery may also contain an electrolyte, such as a liquid or a gel in which a lithium salt is dissolved and in which the salt at least partly dissociates to at least one cation and at least one anion. Typically the electrolyte contains an organic liquid having, for example, carbonate, ether, nitrile or sulfoxide functions. In certain embodiments, the lithium salt may be selected from lithium salts conventionally used in lithium ion secondary batteries. Examples of anions of the lithium salt include perfluoroalcanesulfonates, bis(perfluoroalkylsulfonyl) imides, perchlorate (ClO₄)⁻, hexafluorophosphate (PF₆⁻), hexafluoroarsenate (AsF₆⁻) or tetrafluoroborate (BF₄⁻). The liquid solvent may include an organic liquid, such as a carbonate, particularly an organic carbonate, an ether, a nitrile or sulfoxide, or another ionic liquid. Examples of organic carbonates include propylene carbonate, ethylene carbonate, and dialkyl carbonates (such as cyclic ethylene carbonate, cyclic propylene carbonate, dimethylcarbonate, diethylcarbonate and methylpropylcarbonate). The polymer may include a polar polymer selected from solvating, crosslinked or non-crosslinked polymers. A solvating polymer may include a polymer that contains solvating units containing at least one hetero atom chosen from sulfur, oxygen, nitrogen and fluorine. Example solvating polymers include polyethers of linear, comb or block structure, forming or not forming a network, based on poly(ethylene oxide), or polymers containing the ethylene oxide or propylene oxide or allyl glycidyl ether unit, polyphosphazenes, crosslinked networks based on polyethylene glycol crosslinked with isocyanates or networks obtained by polycondensation and bearing groups that allow the incorporation of crosslinkable groups. In another embodiment, the electrolyte may be a solid electrolyte, particularly one with high ionic conductivity such as a graft co-polymer or nanoporous β-Li₃PS₄.

For sodium ion batteries, the equivalents of materials described above for lithium salts, but with sodium in place of lithium, may be used. In particular, propylene carbonate, ethylene carbonate, and dimethylcarbonate, along with a sodium ion or sodium ion source, may be used alone or in combination.

Electrolytes may combine more than one type of electrolyte material.

Batteries of the present disclosure may be as simple as single electrochemical cells. They may also include multiple-cell arrangements, such as multiple cells arranged in series or in parallel. Cell arrangement may be designed to achieve particular parameters for a battery, such as a particular voltage. Batteries may also include regulatory components, such as safety monitors, cut-off switches, fire suppressants, detectors and monitors. In one embodiment, a battery may include a computer.

Batteries may be used in a variety of devices, including, but not limited to, cell phones, smart phones, computers, handheld electronic devices, automobiles, including cars, trucks, buses, motorcycles, and powered bicycles, watercraft, including boats and jet-skis, power tools and power tool battery packs, backup power sources, including portable backup power sources, battery-powered medical devices and equipment, and grid storage systems.

There may be a synergistic effect between Bi and Sb in the alloy structure, alleviating the polarization problem common in the Sb lithiation/delithiation process, significantly improving the initial coulombic efficiency (ICE) of Bi, and enhancing the lithium-ion diffusion rate. Consequently, the Bi—Sb alloy exhibits high ICE, stable cycle performance, and high rate capacity when used in an electrochemical cell or battery.

The present disclosure further includes a high-energy mechanical milling method for forming as Bi—Sb alloy such as method 100 depicted in FIG. 2. In step 110, Bi powder and Sb powder are mixed. The Bi powder and Sb powder may be the same or different average size. Method 110 may result in a more uniform alloy when the powder are the same size. In addition, one or more of the powders may be 250 mesh or smaller. However, feedstock size is typically not important because size is adequately reduced in the high-energy mechanical milling process Other materials may be included as well, such as a carbon source.

In step 120, the mixed powder is placed in a milling container. For instance, the mixed powder may be placed in a hardened steel chamber. Steps 110 and 120 may be combined such that starting materials are mixed in the milling container. Alternatively, starting materials may even be placed in the milling container without mixing prior to the milling process. Milling balls, such as steel milling balls, may also be placed in the milling container. In step 130, the milling container is placed in inert or unreactive atmosphere, such as an argon-filled glovebox.

In step 140, the milling container is rotated at a speed of at least 300 rpm or at least 500 rpm for at least 5 hours or at least 12 hours.

Sb—Bi alloys formed as described above may be used in other applications. For instance, they may form a high-performance thermoelectric material usable at low temperatures, such as 20-200K.

### EXAMPLES

The present invention may be better understood through reference to the following examples. These examples are included to describe exemplary embodiments only and should not be interpreted to encompass the entire breadth of the invention.

### Example 1—Bi—Sb Alloy Formation

All samples were prepared by a high-energy mechanical milling (HEMM). Bismuth powder (99.9%, 100 mesh), antimony powder (99.5%, 100 mesh), and acetylene black (16.6 wt. %) were mixed and sealed in a hardened steel chamber with steel balls in an argon-filled glovebox. The chamber was then mounted in a PULVERISETTE® (Fritsch GmbH, Germany) 6 planetary mill and rotated at the speed of 500 rpm for 12 h.

### Example 2—SEM-EDS Analysis

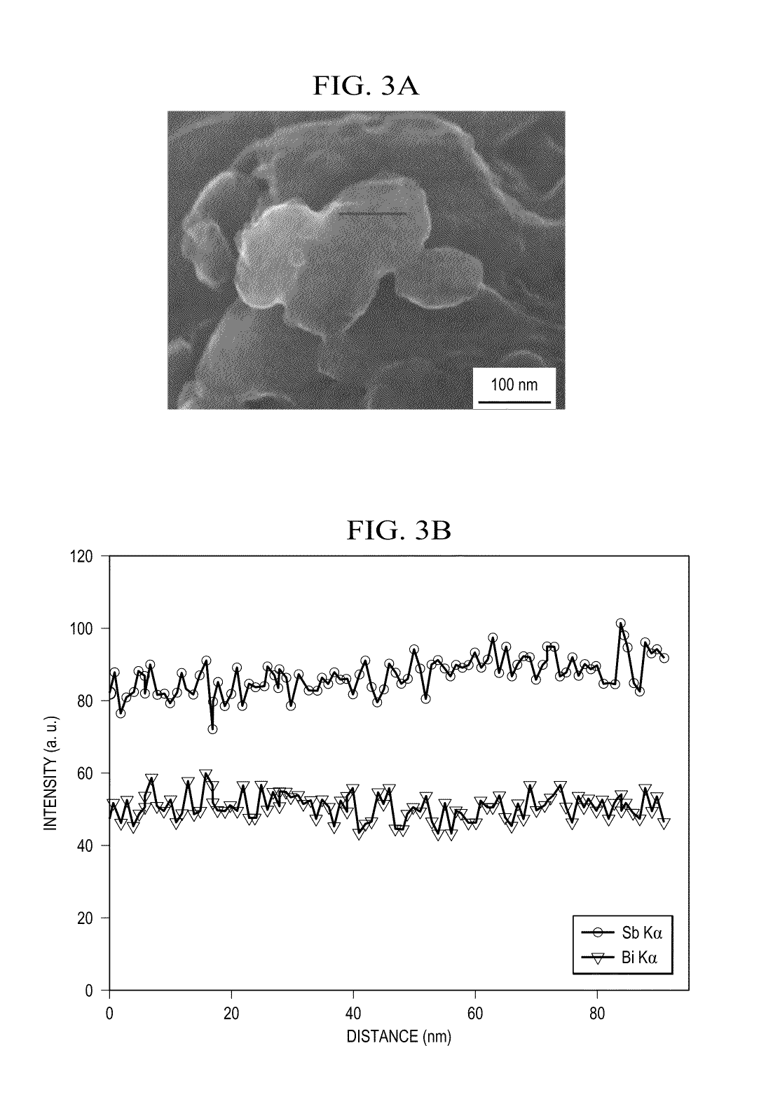

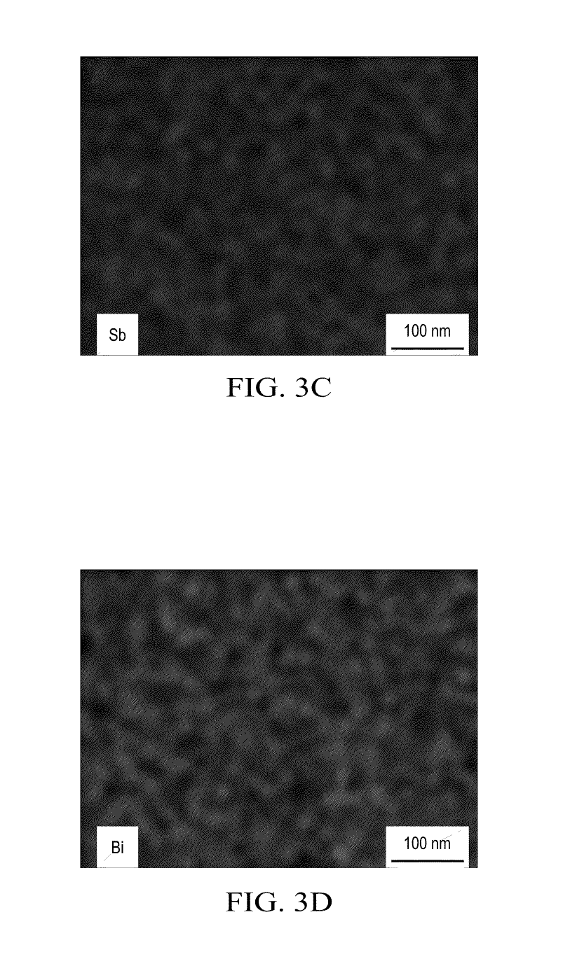

SEM-EDS analysis was carried out with a Hitachi 55500 SEM. Two alloy samples with different Bi/Sb molar ratios denoted by Bi_{0.57}Sb_{0.43}—C and Bi_{0.36}Sb_{0.64}—C as well as Bi—C and Sb—C were prepared. FIG. 3A shows the SEM image of the Bi_{0.36}Sb_{0.64}—C sample, and the elemental distribution of Sb and Bi was characterized by EDS line-scan along the direction marked in the image. As shown in FIG. 3B, the contents of Bi and Sb keep a constant ratio of around 1.7, which indicates that Bi and Sb are distributed uniformly at the nanometer scale along the line. FIGS. 3C and 3D).

### Example 3—X-Ray Diffraction

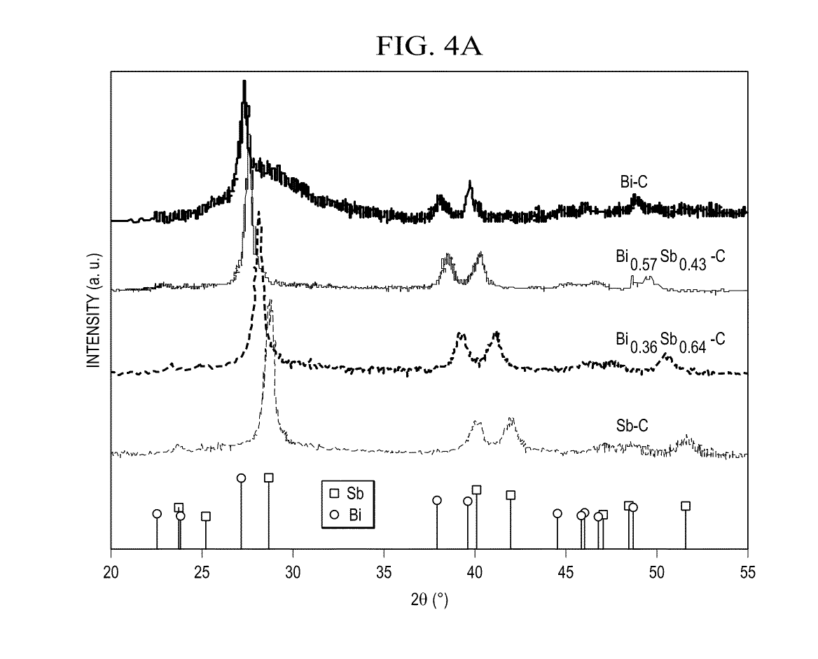

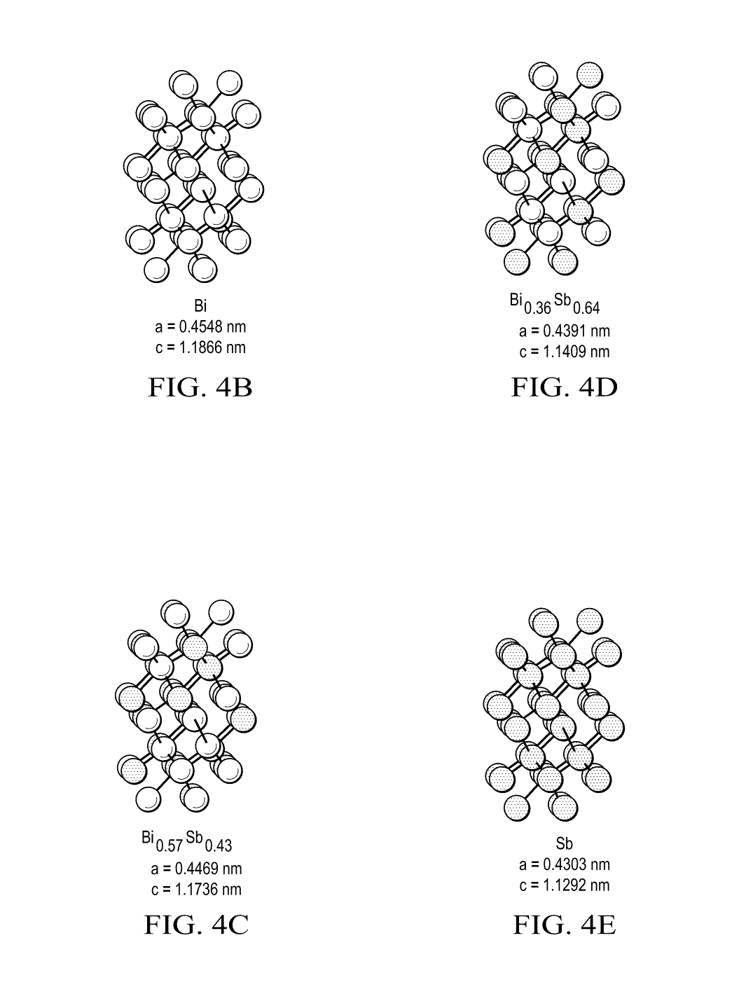

XRD data were collected with a Rigaku Ultima-IV X-ray diffractometer with Cu Kα radiation and used to confirm the crystal structures of the Bi—Sb alloys as shown in FIG. 4A.

Crystal structures for Bi, Sb, and the two alloys as deduced from XRD are shown in FIGS. 4B-E. Bi and Sb have the same crystal structure (R-3m) and therefore present very similar diffraction patterns with only minor differences in the diffraction angles. The strongest (012) diffraction peaks of Bi and Sb are located, respectively, at 27.2° and 28.6°. For the Bi_{0.36}Sb_{0.64}—C and Bi_{0.57}Sb_{0.43}—C samples, the diffraction patterns are very similar to those of Sb and Bi, and no other new peaks were observed. With the increase in Bi content in the samples, all diffraction peaks shift to lower angles due to the substitution of smaller Sb atoms by larger Bi atoms, strongly indicating the formation of homogeneous Sb—Bi alloy phase.

Lattice parameters are provided in TABLE 1.

TABLE 1
Lattice Parameters

| | Space | a (nm) | |
|---|---|---|---|
| Samples | Group | (= b) | c (nm) |
| Bi | R-3m | 0.4548 | 1.1866 |
| Sb | R-3m | 0.4303 | 1.1292 |
| Bi_{0.57}Sb_{0.43} | R-3m | 0.4469 | 1.1736 |
| Bi_{0.36}Sb_{0.64} | R-3m | 0.4391 | 1.1409 |

### Example 4—Electrochemical Cells

In all test electrochemical cells discussed herein, the electrodes were prepared by doctor-blade coating a slurry onto a copper foil. The slurry contained active material, Super P (conductivity enhancer agent), and Poly(vinylidene fluoride) (PVDF, as binder) with a weight ratio of 70:15:15. N-Methyl-2-pyrrolidone (NMP) was employed to adjust the viscosity of the slurry. The electrodes had a diameter of 1.2 cm and the active material (metal alloy-carbon composite) loading was ca. 2 mg per electrode.

The battery performance of the electrodes was assessed with in CR2032 coin cells with Celgard polypropylene as a separator and Li metal as the counter/reference electrode. The coin cells were assembled in an Argon-filled glovebox. The electrolyte for lithium ion cell was 1 M LiPF6 in ethylene carbonate (EC)/diethyl carbonate (DEC) (1: 1 v/v). For the sodium ion cell, glass fiber was employed as the separator. The electrolyte was composed of 1 M NaClO4 in ethylene carbonate (EC)/diethyl carbonate (DEC) (1: 1 v/v) containing 5 (wt.) % fluoroethylene carbonate (FEC) as an additive.

### Example 5—Galvanostatic Measurements

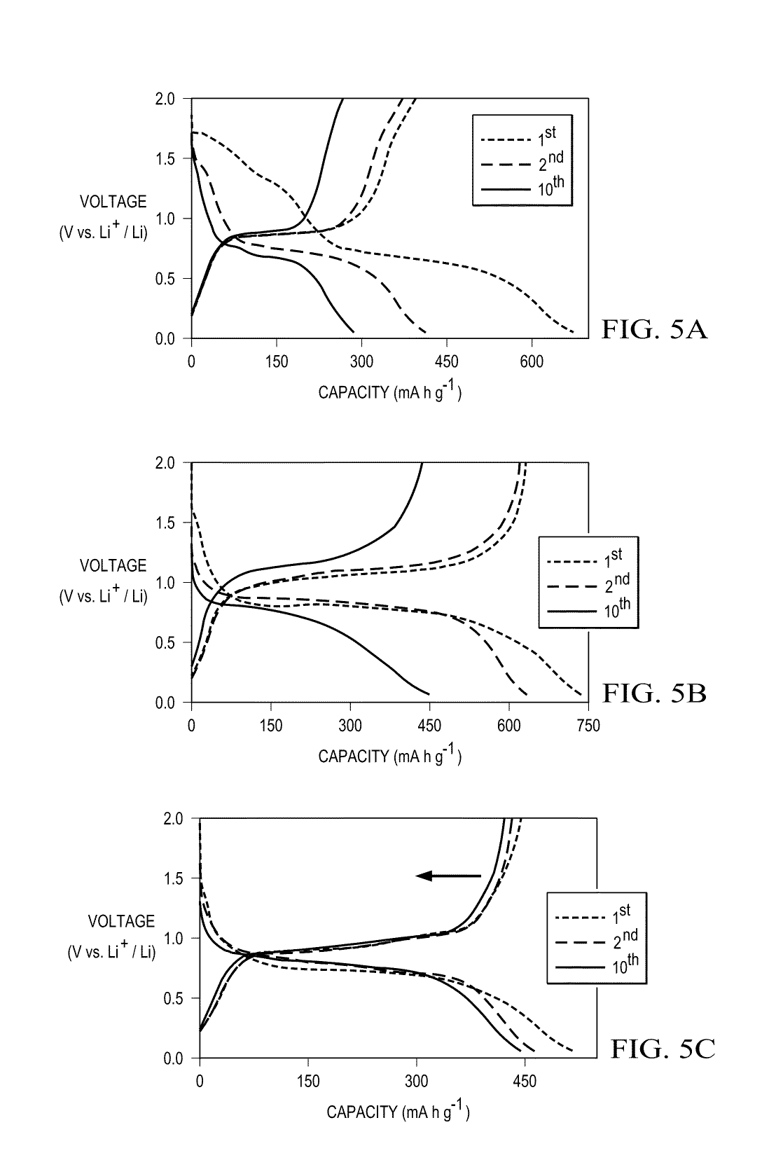

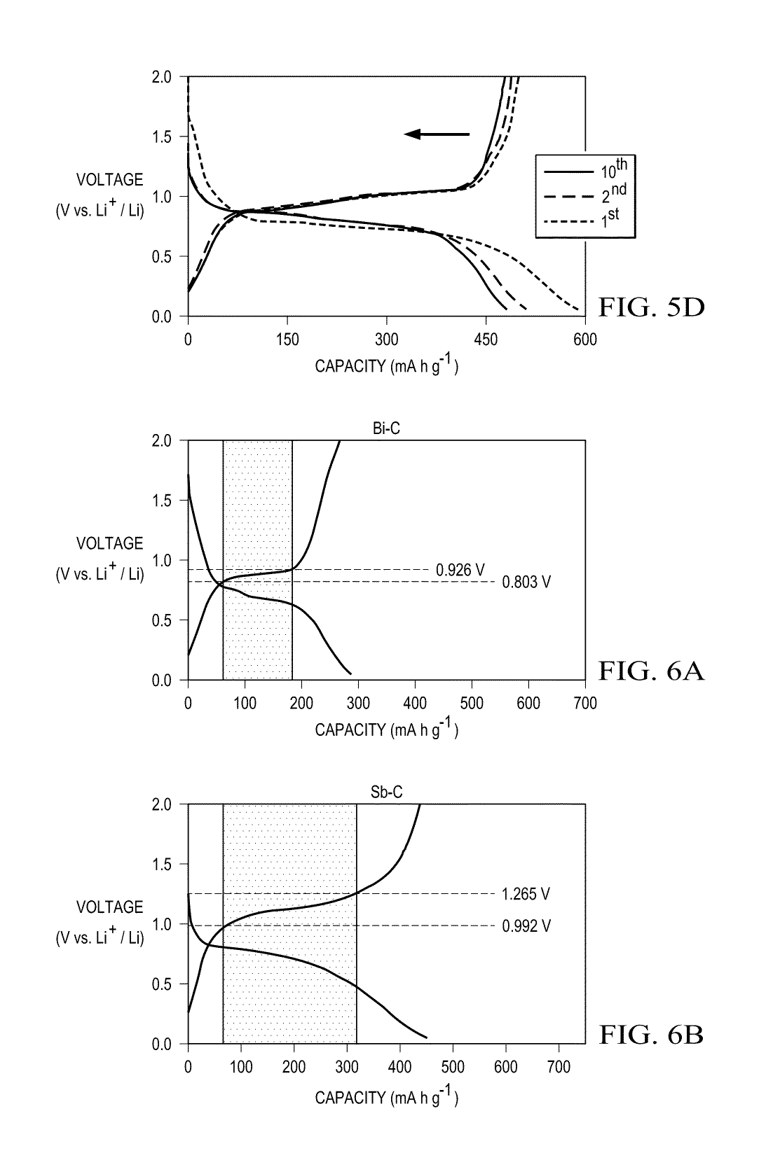

Charge/discharge performance was assessed with an battery cycler under galvanostatic condition in the voltage window of 0.05-2 V. As shown in FIGS. 5A and 5B, both Bi—C and Sb—C composite electrodes exhibit flat delithiation potential plateaus at 0.9 and 1.0 V vs. Li⁺/Li, respectively. However, the Bi—C electrode exhibits a large irreversible capacity loss in the first cycle and the ICE was as low as 58%. Such a low ICE may result from the electrolyte decomposition and formation of SEI on Bi surface, which may eventually waste the limited lithium source in the cathode of a full cell. For the Sb—C electrode, although it has a high ICE of 85% (TABLE 2), polarization becomes increasingly severe in the first few cycles due to the volume change caused pulverization of Sb particles in the electrode.

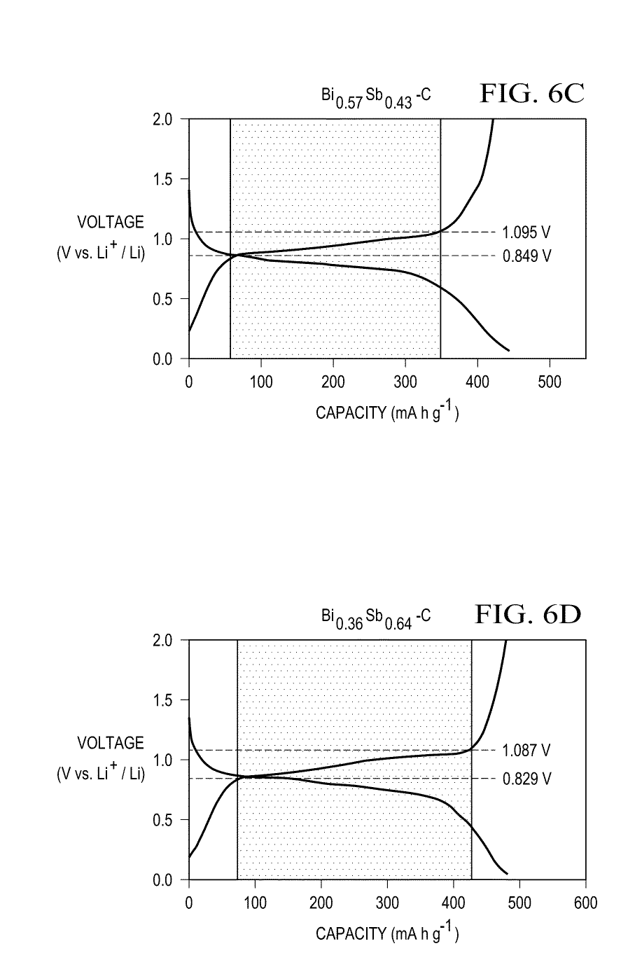

However, when the homogeneous Bi—Sb alloy structure is formed, the electrodes show both high ICE and expanded flat plateau. The ICE of the Bi_{0.57}Sb_{0.43}—C and Bi_{0.36}Sb_{0.64}—C electrodes reach, respectively, as high as 81.7% and 83.1%, which will greatly increase the utilization efficiency of the limited lithium source of the cathode in a full cell (FIGS. 5C and 5D and TABLE 2). Taking the delithiation potential profiles of the electrodes at the 10^{th} cycle as examples, the flat-plateau capacities of the Bi—C and Sb—C electrodes are, respectively, 122 and 246 mA h g⁻¹, while those of the Bi_{0.57}Sb_{0.43}—C and Bi_{0.36}Sb_{0.64}—C electrodes are, respectively, increased to 292 and 360 mA h g⁻¹ (FIG. 6). The expanded potential flat-plateau of the anode allows maximum energy density of the full cell.

TABLE 2
Initial Coulombic Efficiencies (ICE) of the electrodes in lithium-ion and
sodium-ion batteries.

ICE (%)

| Samples | LIB^{a)} | NIB^{b)} |
|---|---|---|
| Bi—C | 58.7 | 66.2 |
| Sb—C | 85.8 | 78.2 |
| Bi_{0.57}Sb_{0.43}—C | 81.7 | 78.9 |
| Bi_{0.36}Sb_{0.64}—C | 83.1 | 79.6 |

^{a)}Lithium ion battery; galvanostatic condition with a current density of 200 mA g⁻¹.
^{b)}sodium-ion battery; galvanostatic condition with a current density of 100 mA g⁻¹.

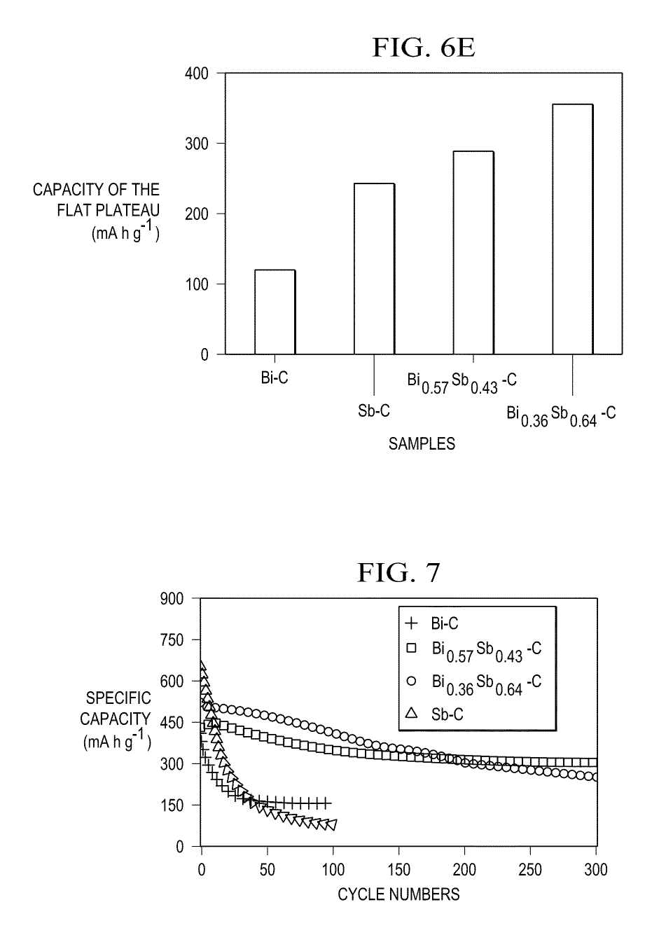

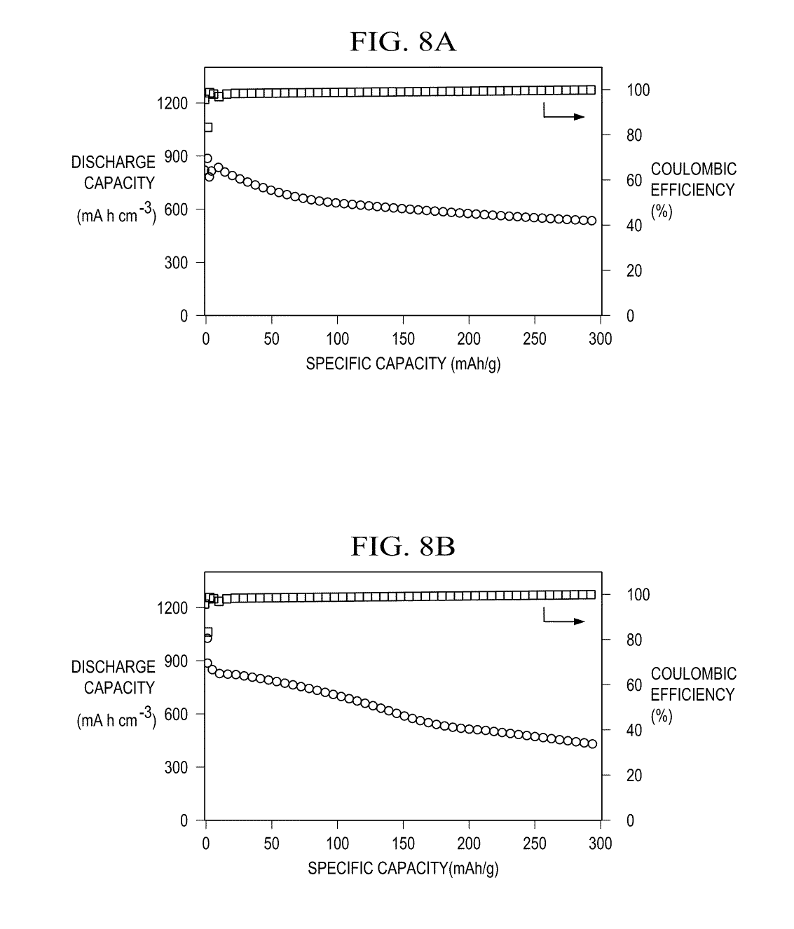

The cycle performance of the electrodes was assessed with galvanostatic conditions at a current density of 200 mA g⁻¹ (FIG. 7). The delithiation capacity of the Sb—C and Bi—C electrodes decays very fast and, only 42% and 21% of the initial delithiation capacity retain after 50 cycles. The cycle stability is significantly improved when Bi and Sb formed a homogeneous alloy structure. For the Bi_{0.36}Sb_{0.64}—C electrode, the initial delithiation capacity is 494 mA h g⁻¹, and at the 100^{th} and 300^{th} cycle, the capacity retention is, respectively, 350 and 249 mA h⁻¹. The Bi_{0.57}Sb_{0.43}—C electrode delivers an initial delithiation capacity of 410 mA h g⁻¹, and 85% and 72% of the delithiation capacity are retained at the 100^{th} and 300^{th} cycle, corresponding to 0.09% capacity decay per cycle. The coulombic efficiency reaches as high as 99.5% after the first few cycles and remain constant in the subsequent cycles for both the alloy electrodes (FIG. 8). The tap density of Bi_{0.57}Sb_{0.43}—C and Bi_{0.36}Sb_{0.64}—C are, respectively, 1.8 and 1.7 g cm⁻³. The homogeneous alloy matrix of Bi—Sb significantly improved capacity retention.

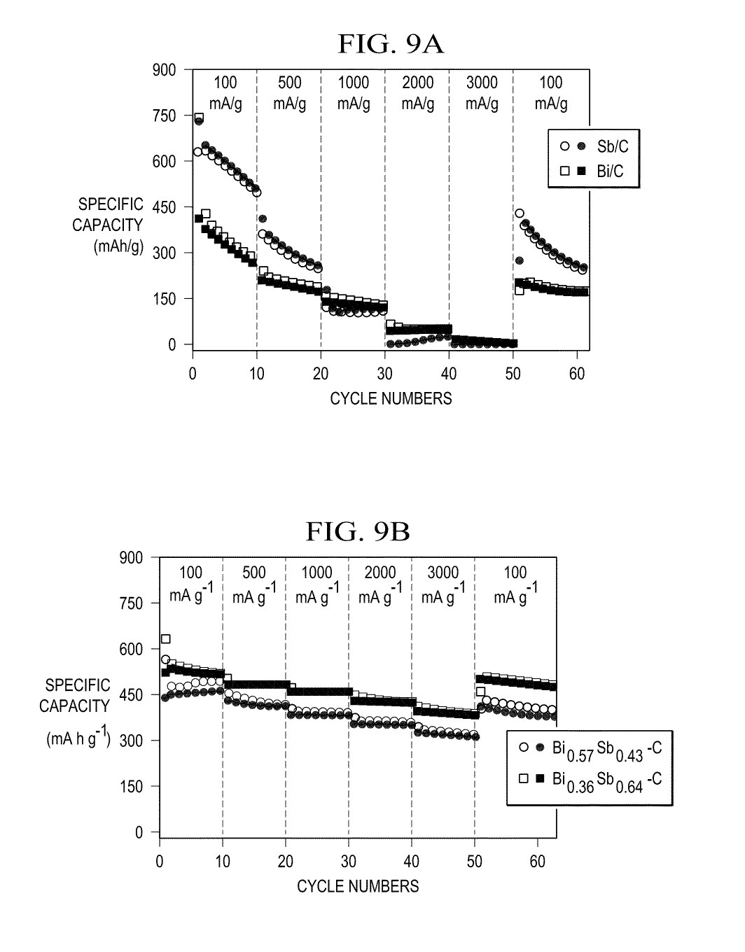

The rate capacity of the electrodes was also measured at the galvanostatic condition. As shown in FIG. 9, with the increase of the current density, the specific capacity decays rapidly for both the Sb—C and Bi—C electrodes. At the current density of the 2,000 mA g⁻¹, their capacities drop to <50 mA h g⁻¹; and there is almost no capacity at the current density of 3,000 mA g⁻¹. This indicates that the lithium-ion diffusion rates in Bi—C and Sb—C electrodes are low. As shown in FIG. 9B, the delithiation capacity of Bi_{0.36}Sb_{0.64}—C is 524, 483, 459, 430, and 396 mA h g⁻¹ at the current density of 100 (0.23 C), 500 (1.15 C), 1,000 (2.30 C), 2,000 (4.60 C), and 3000 mA g⁻¹ (6.90 C). After the high current cycle performance test, the capacity still reaches as high as 501 mA h g⁻¹ at a current density of 100 mA g⁻¹, which is 96% of the initial delithiation capacity. Bi_{0.57}Sb_{0.43}—C also exhibits excellent rate performance (FIG. 9B). The delithiation capacities at the current density of 100 (0.26 C), 500 (1.30 C), 1,000 (2.60 C), 2,000 (5.20 C), and 3,000 mA g⁻¹ (7.80 C) are, respectively, 441, 431, 385, 355, and 326 mA h g⁻¹.

The capacity in the subsequent cycles at the current density of 100 mA g⁻¹ reaches 410 mA h g⁻¹, which is 93% of the initial delithiation capacity. The high C-rate performance of the alloy indicates that the homogeneous Bi—Sb alloy structure is favorable to electron and lithium-ion transport.

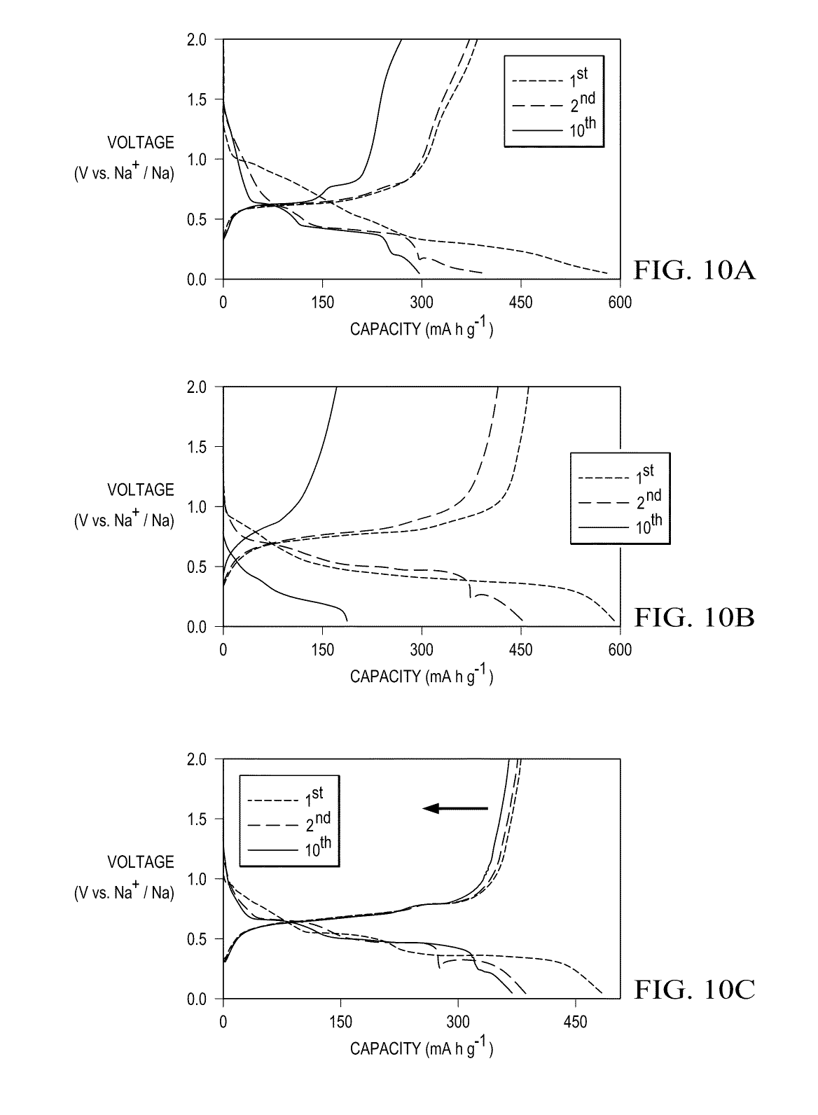

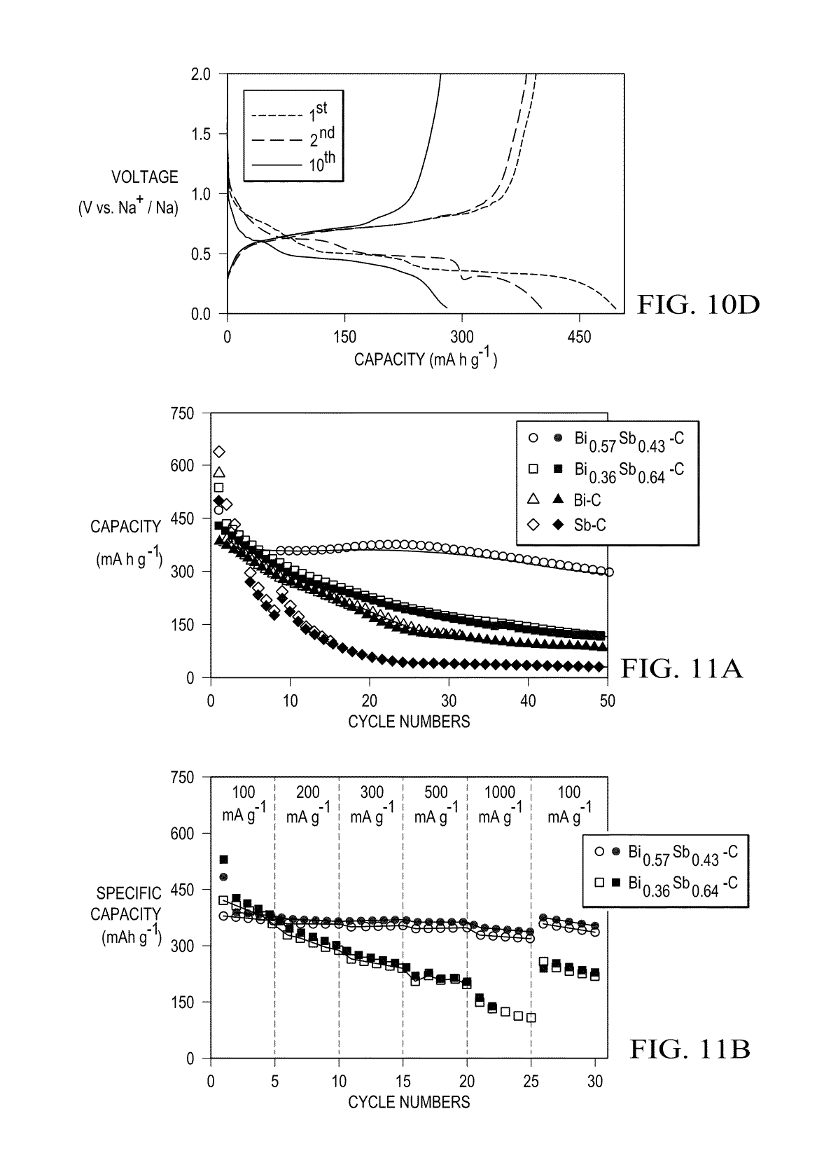

The sodium ion battery performance of the electrodes was measured by galvanostatic method with different current densities. As shown in FIGS. 10A and 10B, both the Bi—C and Sb—C electrodes show three potential plateaus at the second sodiation process, which is obviously different from the first cycle. In the phase diagram of Sb-Na, there are two known alloy compounds: NaSb and Na₃Sb. It has been reported that the sodiation/desodiation mechanism is quite different from the lithiation/delithiation process. The formation of an amorphous intermediate phase NaₓSb (x<3) results in the additional plateau (FIG. 10B). There are also two known Bi—Na alloy compounds: NaBi and Na₃Bi. The sodiation/desodiation process of Bi, also showing three sodiation plateaus, may be similar to that of Sb. The ICE of the Bi—C and Sb—C electrodes are, respectively, 66.2 and 78.2%. While with the alloy electrodes, the ICE of Bi_{0.57}Sb_{0.43}—C and Bi_{0.36}Sb_{0.64}—C are, respectively, increased to 78.9 and 79.6% (TABLE 2).

The cycle stability of the electrodes was measured in the half-cell with sodium as the counter/reference electrode at a current density of 100 mA g⁻¹. For the Sb—C and Bi—C electrodes, their respective first desodiation capacity is 384 and 500 mA h g⁻¹. The capacity decays rapidly and the retained capacity of Bi—C electrode is only 173 mA h g⁻¹ at 20^{th} cycle. With the Sb—C electrode, the 20^{th} cycle capacity is as low as 59 mA h g⁻¹ (FIG. 11A). The fast capacity fade results from severe volume expansion caused by the insertion of the sodium-ion with large radius. As to the alloy electrodes, their cycle performance in sodium ion batteries are more sensitive to the composition of the alloy than that in lithium ion batteries. As shown in FIG. 11A, the first cycle desodiation capacity of Bi_{0.36}Sb_{0.64}—C electrode is 428 mA h g⁻¹, and it decays to 113 mA h g⁻¹ after 50 cycles. While with Bi_{0.57}Sb_{0.43}—C, the cycle stability largely improves and the 50^{th} cycle desodiation capacity is 293 mA h g⁻¹, corresponding to 0.4% capacity decay per cycle. In addition, Bi_{0.57}Sb_{0.43}—C exhibits good rate performance. The delithiation capacities at the current density of 100 (0.26 C), 200 (0.52 C), 300 (0.78 C), 500 (1.3 C), and 1,000 mA g⁻¹ (2.6 C) are, respectively, 393, 370, 362, 357, and 326 mA h g⁻¹. After the high C rate cycles, the capacity in the subsequent cycle at a current density of 100 mA g⁻¹ reaches 370 mA h g⁻¹, which is 94% of the initial desodiation capacity (FIG. 11B). The Bi—Sb alloy structure may function as a stable host for fast sodiation/desodiation process.

Moreover, the volumetric capacity is more important than gravimetric capacity in certain applications. Bi_{0.36}Sb_{0.64}—C and Bi_{0.57}Sb_{0.43}—C have high tap densities of, respectively, 1.7 and 1.8 g cm⁻³. The high tap density of the alloy electrodes result in high volumetric capacities in lithium ion batteries and sodium ion batteries.

### Example 6—Cyclic Voltammetry Measurements

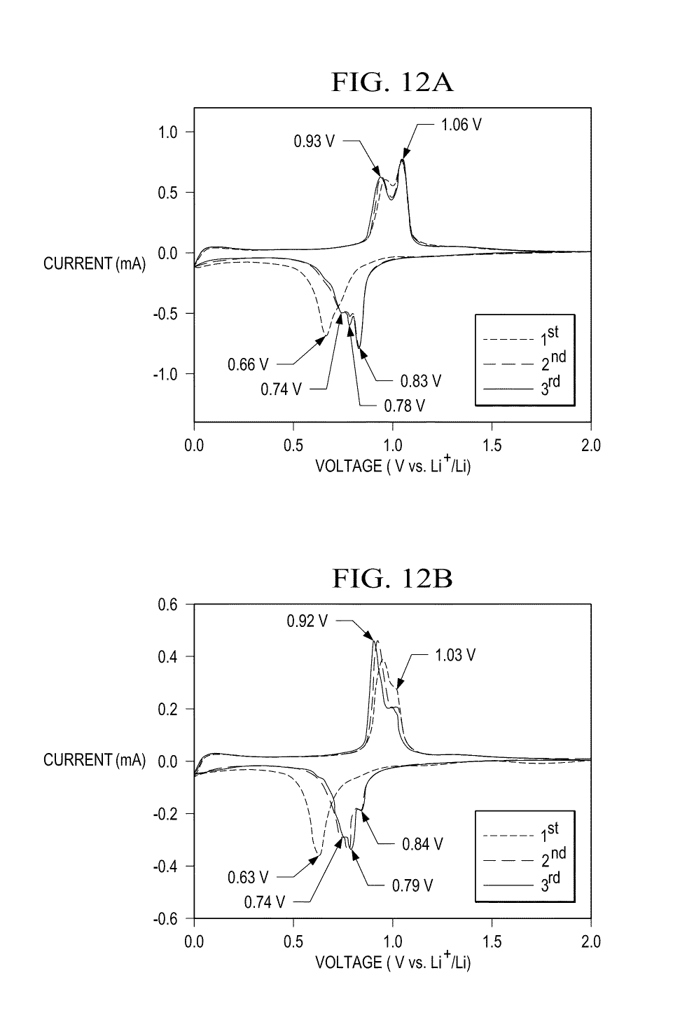

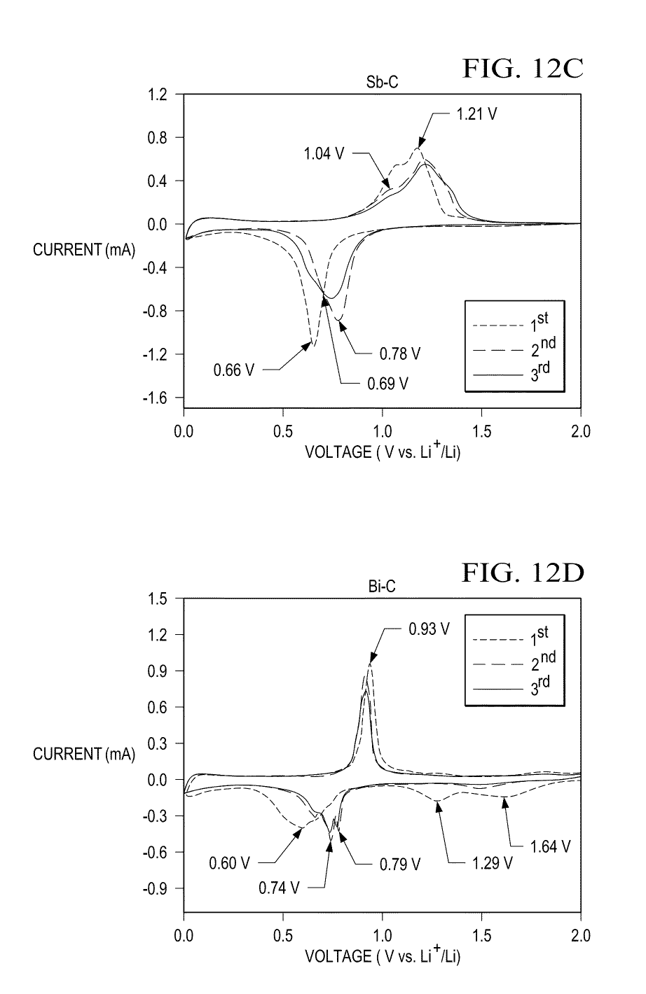

Cyclic voltammetry scan was conducted on VoltaLab PGZ402 at a scan rate of 0.05 mV s⁻¹ between the voltage window of 0.05 and 2.0 V. FIG. 12 shows the CV scan profiles of the initial three cycles of the alloy electrodes at a scan rate of 0.05 mV s⁻¹ between 0 and 2 V (vs. Li⁺/Li). The broad current peak at 0.66 V in the first lithiation scan of Bi_{0.36}Sb_{0.64}—C electrode shifts to higher voltage and split into three current peaks at 0.83, 0.78, and 0.74V (FIG. 12A). The current peak at 0.83 V corresponds to the transition of Sb to Li₃Sb; the peaks at 0.78 and 0.74 V are, respectively, attributed to the conversion of Bi to LiBi and Li₃Bi phases. During the anodic scan, the current peaks at 0.93 and 1.06 V result from the delithiation of Li₃Bi and Li₃Sb, producing Bi—Sb alloy. For the Bi_{0.36}Sb_{0.64}—C electrode, the current peaks appear at the same voltage but with different peak intensity due to the difference in the Bi/Sb molar ratio (FIG. 12B).

As shown in FIG. 12C, the cathodic and anodic current peaks of Sb—C occur, respectively, at 0.78 and 1.21 V, while in the alloy, the cathodic and anodic current peaks shift, respectively, to higher and lower voltages of 0.83 and 1.06 V. This indicates that the formation of Bi—Sb alloy phase is positive to alleviate the polarization during the lithiation/delithiation of Sb. With the Bi—C electrode, the current peaks of Bi lithiation and delithiation are located at the same voltage to that in the alloy structure (FIG. 12D). At the first cycle, the anodic current peaks at 1.29 and 1.64 V are derived from the electrolyte decomposition and SEI layer formation on Bi surface, leading to large initial capacity loss. While when Bi atoms are homogeneously dispersed in the Bi—Sb alloy matrix, these peaks disappear, indicating the side reactions on the Bi surface have been effectively restricted.

Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances particularly outside of the examples other values similar to, but not exactly the same as the given measurements may be equivalent and may also be encompassed by the present invention. As another example, one of ordinary skill in the art would recognize that, in at least some embodiments, a lithium ion battery or a sodium ion battery may also include batteries where the alkali metal is a mixture of sodium and lithium.

1. A rechargeable battery comprising:
an anode comprising a bismuth (Bi)-antimony (Sb) alloy;
a cathode; and
an electrolyte comprising an ion.

2. The battery of claim 1, wherein the ratio of Bi: Sb is between 1:9 and 9:1.

3. The battery of claim 1, wherein the ion is a lithium ion (Li⁺).

4. The battery of claim 3, wherein the anode further comprises a Li—Bi compound or a Li—Sb compound, or both.

5. The battery of claim 1, wherein the ion is a sodium ion (Na^{+).}

6. The battery of claim 5, wherein the anode further comprises a Na—Bi compound or a Na—Sb compound.

7. The battery of claim 1, wherein the Bi—Sb alloy is homogenous.

8. The battery of claim 1, wherein the Bi—Sb alloy has a crystal structure in the R-3m space group.

9. The battery of claim 1, wherein the anode further comprises elemental carbon (C).

10. The battery of claim 1, where the voltage changes less than 5% during a time frame that represents 90% of the time required for charge or discharge of the battery.

11. The battery of claim 1, wherein the cathode comprises a transition-metal oxide able to provide a host framework into which the ion may be reversibly inserted and extracted.

12. The battery of claim 1, wherein the ion comprises lithium ion and the cathode comprises a lithium transition-metal oxide, a lithium transition-metal polyanion oxide, a peroxide, sulfur, a sulfur-polymer, or a sulfoselenide.

13. The battery of claim 1, wherein the ion comprises sodium ion and the cathode comprises Na₂FePO₄F, NaVPO₄F, NaV₁₋ₓCrₓPO₄F, NaₓVO₂, Na₄Fe(CN)₆, Na_{1.5}VPO_{4.8}F_{0.7}, P2-Naₓ[Ni_{1/3}Mn_{2/3}]O₂, wherein (0<x<2/3), or a sodium-containing layered oxide.

14. The battery of claim 1, wherein the electrolyte comprises an organic liquid and a salt of the ion.

15. The battery of claim 1, wherein the battery comprises a regulatory component.

16. The battery of claim 1, wherein the battery comprises a computer.

17. A method of forming a bismuth (Bi)-antimony (Sb) alloy comprising:
mixing a Bi powder and a Sb powder, both with a grain size of 250 mesh or smaller;
placing the powder in a milling box;
placing the milling box in an inert or unreactive atmosphere;
rotating the milling box in the inert or unreactive atmosphere at a speed of at least 300 rpm for at least 5 hours.

18. The method of claim 17, further comprising mixing a carbon source with the Bi powder and the Sb powder.

19. The method of claim 17, wherein rotation comprises rotating the milling box for at least 500 rpm for at least 12 hours.
